(19) United States
(12) Patent Application Publication
(10) Pub. No.: US 2026/0206040 A1
(43) Pub. Date: Jul. 16, 2026

(54) METHOD, DEVICE AND COMPUTER STORAGE MEDIUM OF COMMUNICATION

(71) Applicant: NEC Corporation, Tokyo (JP)

(72) Inventors: Zhaobang MIAO, Beijing (CN); Gang WANG, Beijing (CN)

(73) Assignee: NEC Corporation, Tokyo (JP)

(21) Appl. No.: 19/136,483

(22) PCT Filed: Dec. 8, 2022
(86) PCT No.: PCT/CN2022/137553

§ 371 Date: Jun. 6, 2025

(51) Int. Cl. H04W 72/25; H04L 5/00; H04W 52/02

(52) U.S. Cl. CPC H04W 72/25; H04L 5/0044; H04W 52/0235

(57) ABSTRACT

Embodiments of the present disclosure relate to methods, devices, and computer readable medium for communication. According to embodiments of the present disclosure, if a terminal device transmits common information on the sidelink, the terminal device determines a first transmission power for the common information based on a reference transmission power and a power reduction value. In this case, the terminal device transmits the common information at the first transmission power. If the terminal device transmits HARQ feedback information, the terminal device transmits the HARQ feedback information at a second transmission power. In this way, more remaining power can be used for the HARQ feedback information and the transmission of HARQ feedback information can be improved.

### TECHNICAL FIELD

Embodiments of the present disclosure generally relate to the field of telecommunication, and in particular, to methods, devices and computer storage media of communication for power control of sidelink transmissions.

### BACKGROUND

With developments of communication technologies, terminal devices can perform direct communication with each other by setting up a sidelink therebetween and utilizing unlicensed spectrum.

Channel access mechanisms from New Radio Unlicensed (NR-U) are proposed to be reused for sidelink unlicensed operations. If the existing NR-U channel access framework does not support the required Sidelink-Unlicensed (SL-U) functionality, appropriate recommendations need to be made. Regarding the physical channel design framework, changes are required to NR sidelink physical channel structures and procedures to operate on unlicensed spectrum.

### SUMMARY

In general, embodiments of the present disclosure provide methods, devices and computer storage media for power control of sidelink transmissions.

In a first aspect, there is provided a terminal device. The terminal device comprises a processor configured to cause the terminal device to: obtain a configuration that comprises power control information concerning a sidelink transmission related to the terminal device; in accordance with a determination of common information to be transmitted on a set of common resources, transmit, to a second terminal device, the common information at a first transmission power, wherein the first transmission power is determined based on a reference transmission power in the power control information and a power reduction value; and in accordance with a determination of hybrid-automatic repeat request acknowledgement (HARQ-ACK) information to be transmitted on a set of dedicated resources, transmit, to the second terminal device, the HARQ-ACK information at a second transmission power.

In a second aspect, there is provided a terminal device. The terminal device comprises a processor configured to cause the terminal device to: determine a plurality of physical sidelink feedback channel (PSFCH) transmissions in a PSFCH occasion, wherein the plurality of PSFCH transmissions is used for at least one of: hybrid automatic repeat request acknowledgment (HARQ-ACK) information, conflict information and common occupied channel bandwidth (OCB) information; and perform a PSFCH transmission for the common OCB information with another terminal device based on priority information associated with the common OCB information.

In a third aspect, there is provided a network device. The network device comprises a processor configured to cause the network device to: transmit a configuration that comprises power control information concerning a sidelink transmission related to the terminal device, wherein a first transmission power for transmitting common information on a set of common resources is determined based on a reference transmission power in the power control information and a power reduction value, and a second transmission power for transmitting hybrid-automatic repeat request acknowledgement (HARQ-ACK) information on a set of dedicated resources is determined based on the reference transmission power and a power increased value.

In a fourth aspect, there is provided a communication method. The communication method comprises: obtaining, at a first terminal device, a configuration that comprises power control information concerning a sidelink transmission related to the terminal device; in accordance with a determination of common information to be transmitted on a set of common resources, transmit, to another terminal device, the common information at a first transmission power, wherein the first transmission power is determined based on a reference transmission power in the power control information and a power reduction value; and in accordance with a determination of hybrid-automatic repeat request acknowledgement (HARQ-ACK) information to be transmitted on a set of dedicated resources, transmit, to the other terminal device, the HARQ-ACK information at a second transmission power.

In a fifth aspect, there is provided a communication method. The communication method comprises: determining, at a first terminal device, a plurality of physical sidelink feedback channel (PSFCH) transmissions in a PSFCH occasion, wherein the plurality of PSFCH transmissions is used for at least one of: hybrid automatic repeat request acknowledgment (HARQ-ACK) information, conflict information and common occupied channel bandwidth (OCB) information; and performing a PSFCH transmission for the common OCB information with a second terminal device based on priority information associated with the common OCB information.

In a sixth aspect, there is provided a communication method. The communication method comprises: transmitting a configuration that comprises power control information concerning a sidelink transmission related to the terminal device, wherein a first transmission power for transmitting common information on a set of common resources is determined based on a reference transmission power in the power control information and a power reduction value, and a second transmission power for transmitting hybrid-automatic repeat request acknowledgement (HARQ-ACK) information on a set of dedicated resources is determined based on the reference transmission power and a power increased value.

In a seventh aspect, there is provided a computer readable medium having instructions stored thereon, the instructions, when executed on at least one processor, causing the at least one processor to carry out the method according to the fourth, fifth, or sixth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIGS. 3A and 3B illustrate schematic diagrams of sidelink resource allocations according to some example embodiments of the present disclosure, respectively;

FIG. 4 illustrates a schematic diagrams of sidelink resources according to some example embodiments of the present disclosure;

FIGS. 5A and 5B illustrate schematic diagrams of reserved resources according to some example embodiments of the present disclosure, respectively;

FIG. 6 illustrates a signaling flow for communications according to some embodiments of the present disclosure;

FIG. 7 is a flowchart of an example method in accordance with an embodiment of the present disclosure;

FIG. 8 is a flowchart of an example method in accordance with an embodiment of the present disclosure;

FIG. 9 is a flowchart of an example method in accordance with an embodiment of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space bome vehicles or Air bome vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains. In this context of the present disclosure, the term “common resource” may refer to any resource that can be used or shared among a plurality of terminal devices. The term “dedicated resource” may refer to any resource that is used by a specific terminal device. The term “physical resource block (PRB)” used herein may refer to an element of resource allocation which comprises several (for example, 12) consecutive subcarriers for one slot.

In this context, the term “Hybrid Automatic Repeat Request (HARQ)” used herein may refer to a combination of high-rate forward error correction (FEC) and automatic repeat request (ARQ) error-control. The term “HARQ-ACK feedback” or “HARQ-ACK information” used herein may refer to feedback for the HARQ which may include acknowledgment (ACK) or non-acknowledgement (NACK). The term “Power Spectral Density (PSD)” used herein may refer to the measure of signal's power content versus frequency. A PSD is typically used to characterize broadband random signals. The amplitude of the PSD is normalized by the spectral resolution employed to digitize the signal. 1s The term “occupied channel bandwidth (OCB)” used herein may refer to a channel bandwidth requirement of unlicensed spectrum.

In this context, the term “sidelink” may refer to a direct proximity-based cellular connection. The term “sidelink transmission” may refer to any transmission between end devices (for example, UE). Sidelink physical channels include Physical Sidelink Broadcast Channel (PSBCH), Physical Sidelink Control Channel (PSCCH), Physical Sidelink Shared Channel (PSSCH) and Physical Sidelink Feedback Channel (PSFCH). PSCCH and PSFCH are standalone channels. PSCCH carries apart of Sidelink Channel Information (SCI), the other part going on PSSCH. The term “physical sidelink feedback channel (PSFCH)” used herein may refer to a sidelink channel that carries HARQ feedback for sidelink transmissions received on physical sidelink shared channel (PSSCH). The term “PSFCH occasion” used herein may refer to a time-frequency domain resource within which a PSFCH transmission can be performed. The term “transmission (TX) terminal device” used herein can refer to a terminal device which can transmit data to another terminal device when performing sidelink communications with the other terminal device. The term “receiving (RX) terminal device” used herein can refer to a terminal device which can receive data from another terminal device when performing sidelink communications with the other terminal device. The term “common information” used herein can refer to any information that is common to a group of terminal devices, such as, common information to fulfill OCB requirement. The term “conflict information” used herein may refer to information indicating the transmissions conflict occurs on a certain resource.

As discussed above, since existing NR-U channel access framework may not support all the required SL-U functionality, some changes need to be made. Resources for sidelink communications can be scheduled by a network device, which is referred to as mode 1. On the other hand, resources for sidelink communication can also be determined by UE itself, which is referred to as mode 2. Specifically, as a sidelink communication enhancement, the inter-UE coordination is proposed for mode 2 resource allocation to improve reliability where one of the UEs determines a set of resources and transmits such set of resources to another UE which takes them into consideration when performing resource selection for its own transmission. Sidelink on unlicensed spectrum can be supported for both mode 1 and mode 2. For PSFCH and SL-HARQ in SL-U, it is worth studying how to meet OCB and PSD requirement for PSFCH transmission. Regarding PSFCH transmission, at least the followings solutions may be further studied: solution (1) each PSFCH transmission occupies a common interlace and zero or one or more dedicated PRB; solution (2) each PSFCH transmission occupies an interlace and may or may not further apply code domain enhancement; and solution (3) each PSFCH transmission occupies some dedicated PRBs and some common PRBs.

The transmission on common resources may limit the remaining power used for HARQ-ACK information transmission on dedicated resources, thus impact the PSFCH/HARQ-ACK coverage. Moreover, how to handle the PSFCH transmission capability and prioritization is not clear. In some solutions, each PSFCH will use the common interlace and dedicated PRB for transmission. While if the dedicated PRB for PSFCH and one of PRBs of the common interlace is within 1 MHz bandwidth, the transmission power will be shared between these 2 PRBs because of PSD limitation of regulation. That will result in less transmission power of PSFCH PRB and reduce the PSFCH coverage or degrade PSFCH performance. In some other solutions, the UE multiplexing capacity for PF0 PSFCH is, therefore, about 10 times less than using the conventional 1-RB PSFCH waveform. For the groupcast, the PSFCH capacity could be a bigger issue as multiple receivers need to be hashed to different CS pairs/interlaces within the PSFCH resource pool. For the above solution (2), one may consider repeating the PSFCH symbols in time domain and apply time domain OCC (TD-OCC) on PSFCH symbols. For both PF0/PF2 PSFCH, interlaced PSFCH symbol can be repeated 2/4 times in time-domain and time domain OCC 2/4 could be applied. This solution does not suffer from reduced transmit power for A/N carrying interlaced RBs under PSD limit of 10 dBm/MHz as in solutions (1) and (3) since all the IRBs are used to carry A/N. However, it does not solve PSFCH capacity issue. Another approach is to additionally use common interlace. However, in this case, most TX power may not be used to convey HARQ-ACK information. In other words, due to PSD restriction, SL HARQ-ACK detection performance may be highly degraded.

Embodiments of the present disclosure provide a solution on PSFCH transmissions. According to embodiments of the present disclosure, if a terminal device transmits common information on the sidelink, the terminal device determines a first transmission power for the common information based on a reference transmission power and a power reduction value. In this case, the terminal device transmits the common information at the first transmission power. If the terminal device transmits HARQ feedback information, the terminal device transmits the HARQ feedback information at a second transmission power. In this way, more remaining power can be used for the HARQ feedback information and the transmission of HARQ feedback information can be improved. The terminal device also transmits the HARQ feedback information on a PSFCH based on priority information related to the HARQ feedback information. In this way, it can solve transmissions limitations.

Principles and implementations of the present disclosure will be described in detail below with reference to the figures.

### Example of Communication Network

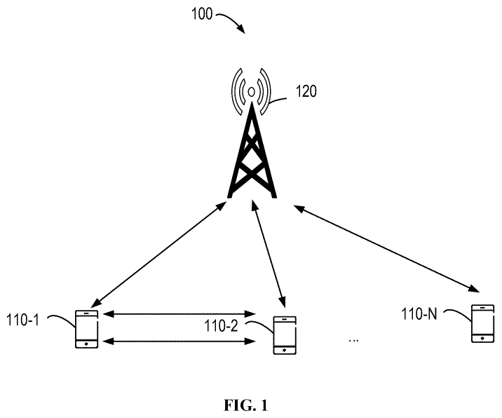

FIG. 1 illustrates a schematic diagram of an example communication network 100 in which some embodiments of the present disclosure can be implemented. As shown in FIG. 1, the communication network 100 may include a network device 120. The communication network 100 may also include a terminal device 110-1, a terminal device 110-2, . . . , a terminal device 110-N (collectively referred to as “terminal device 100”), wherein N is an integer number. In some embodiments, the network device 120 may provide a cell to serve one or more terminal devices. Alternatively, the terminal device(s) 110 may be out of coverage of the network device 120.

It is to be understood that the number of devices in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

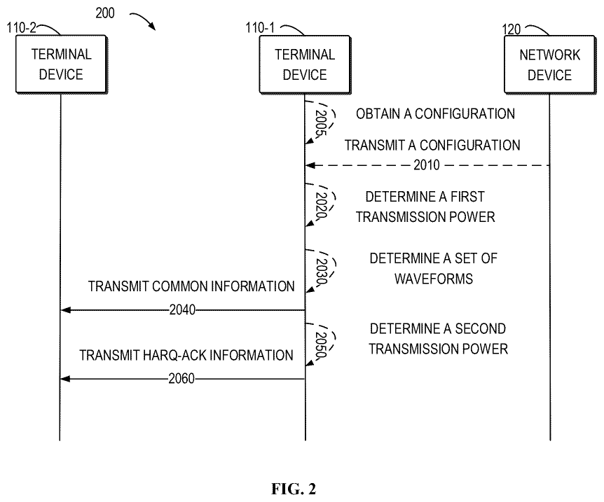

Embodiments of the present disclosure will be described in detail below. Reference is first made to FIG. 2, which shows a signaling chart illustrating process 200 among the terminal device and the network device according to some example embodiments of the present disclosure. Only for the purpose of discussion, the process 200 will be described with reference to FIG. 1. For example, the process 200 may involve the terminal device 110-1, the terminal device 110-2 and the network device 120.

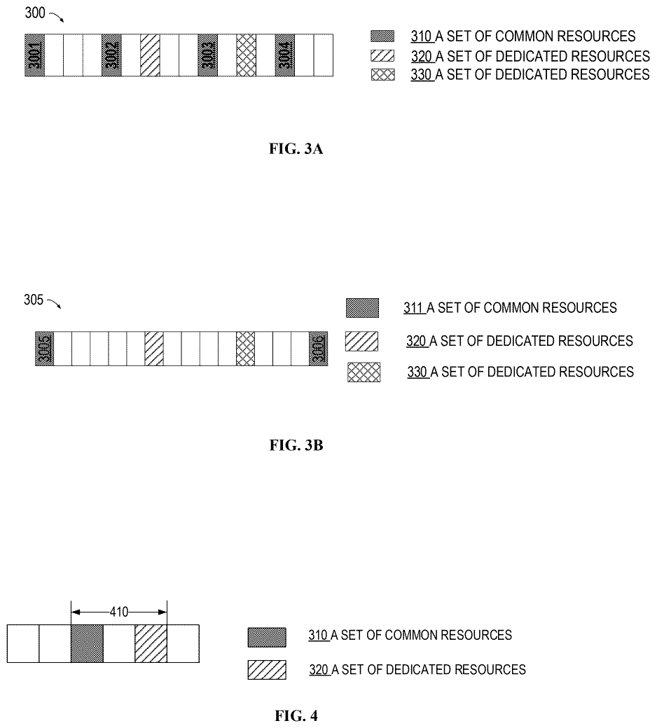

The terminal device 110-1 may be configured with a plurality of sidelink resources. For example, the terminal device 110-1 may be configured with a set of common resources. The set of common resources may be used for transmit common information. In some embodiments, the set of common resources may include a number of interlace PRBs. Alternatively, the set of common resources may include a number of PRBs located in at least one boundary of a resource block set for the sidelink transmission. The terminal device 110-1 may also be configured with a set of dedicated resources. For example, the set of dedicated resources may include a number of PRBs. FIG. 3A shows a schematic diagram 300 of resource allocations according to an example embodiment of the present disclosure. As shown in FIG. 3A, the terminal devices 110-1 and 110-2 may be configured with the set of common resources 310 which includes a number of interlaced PRBs (shown as PRBs 3001, 3002, 3003 and 3005) within a resource block set 300. FIG. 3B shows a schematic diagram of resource allocations according to another example embodiment of the present disclosure. The terminal devices 110-1 and 110-2 may be configured with the set of common resources 311. As shown in FIG. 3B, the set of common resources 311 may include the PRBs 3005 and 3006 which locate at boundaries of the resource block set 305. As shown in FIGS. 3A and 3B, the terminal device 110-1 may be configured with the set of dedicated resources 320. The set of dedicated resources 330 may be configured for the terminal device 110-2. It is noted that the number of PRBs/resources shown in FIGS. 3A and 3B is only an example not limitation.

The terminal device 110-1 obtains (2005) a configuration. The configuration includes power control information about a sidelink transmission related to the terminal device 110-1. In some embodiments, the configuration may be obtained from high layer parameters. For example, the configuration may be obtained from radio resource control (RRC) parameters. In some embodiments, the network device 120 may transmit (2010) the configuration to the terminal device 110-1. Alternatively, the configuration may be pre-configured at the terminal device 110-1.

In some embodiments, the configuration may indicate a reference transmission power. For example, the reference transmission power may be: P_{PSFCH,one}=P_{O,PSFCH}+10 log₁₀(2^{μ})+α_{PSFCH}·PL [dBm], where P_{O,PSFCH} represents a value of dl-P0-PSFCH, α_{PSFCH} represents a value of dl-Alpha-PSFCH, if provided; else, α_{PFSCH}=1 PL=PL_{b,f,c}(q_{d}) when the active SL BWP is on a serving cell c except that: the RS resource is the one the UE uses for determining a power of a PUSCH transmission scheduled by a DCI format 0_0 in serving cell c when the UE is configured to monitor PDCCH for detection of DCI format 0_0 in serving cell c; the RS resource is the one corresponding to the SS/PBCH block the UE uses to obtain MIB when the UE is not configured to monitor PDCCH for detection of DCI format 0_0 in serving cell c. Alternatively, the reference transmission power may be: P_{PSFCH,common}=P_{O,PSFCH}+10 log₁₀(2^{μ}*N1)+α_{PSFCH}−PL [dBm]. In this case, N1 may represent the number of common resources for the transmission of common information.

If the common information is to be transmitted on the set of common resources (for example, the set of common resources 310 or 311), the terminal device 110-1 may determine (2020) a first transmission power based on the reference transmission power and a power reduction value. The configuration may indicate a power reduction value. For example, the power reduction value may be Y dBm power reduction, where Y is an integer number, for example, Y may be 3 or 10. For example, in some embodiments, the first transmission power may be determined as: P_{PSFCH,common}=P_{O,PSFCH}+10 log₁₀(2^{μ}*N1)+α_{PSFCH}·PL-Y[dBm]. In some embodiments, the terminal device 110-1 may reduce the transmission power on each resource of the set of common resources. Alternatively, the terminal device 110-1 may reduce the transmission power on a subset of the set of common resources.

In some embodiments, the terminal device 110-1 may determine the first transmission power based on the reference transmission power and the power reduction value, if a certain condition is satisfied. In other words, the determination of the first transmission power may be triggered based on the certain condition. For example, the condition may be related to PSD. In some embodiments, the condition may be that power in a predetermined bandwidth exceeds a PSD limit threshold. In this case, if the power in the predetermined bandwidth exceeds the PSD limit threshold, the terminal device 110-1 may reduce the reference transmission power to obtain the first transmission power. By way of example, as shown in FIG. 4, if the power in the bandwidth 410 (for example, 1 MHz) exceeds the PSD limit (for example, 10 dBm/MHz), the terminal device 110-1 may obtain the first transmission power by reducing the reference transmission power. In this way, the PSD limit requirement can be satisfied.

The terminal device 110-1 transmits (2040) the common information at the first transmission power to the terminal device 110-2. In this way, more remaining power can be used for HARQ-ACK/NACK information on dedicated resources.

In some other embodiments, the terminal device 110-1 may determine (2030) a set of waveforms for the transmission of the common information. The set of waveforms may be different phase positions. For example, the set of waveforms or the phase positions may be determined based on an identity (ID) of the terminal device 110-1. It is noted that the ID may be any proper ID that can identify the terminal device 110-1. In this way, it can mitigate In-Band Emission (IBE). In some embodiments, the common information may be transmitted in the set of waveforms at the first transmission power. Alternatively, the common information may be transmitted in the set of waveforms without reducing the transmission power. For example, the common information may be transmitted in the set waveforms with the reference transmission power. In other words, the waveforms with different phase positions for the common information and the reduced transmission power for the common information may be combined in one example embodiment or may be implemented separately in different embodiments.

If HARQ-ACK information is to be transmitted on the set of dedicated resources (for example, the set of dedicated resources 320), the terminal device 110-1 may determine (2050) a second transmission power for the HARQ-ACK information. In some embodiments, the HARQ-ACK information may indicate a HARQ-ACK. Alternatively, the HARQ-ACK information may indicate a HARQ-NACK. The terminal device 110-1 transmits (2060) the HARQ-ACK information to the terminal device 110-2 at the second transmission power. As mentioned above, since the transmission power for the common information is reduced, more remaining power can be used for HARQ-ACK/NACK information on dedicated resources. In this case, as a consequence, the number of PSFCH transmissions of the HARQ-ACK information may be increased.

In some embodiments, the configuration may indicate a power increased value. For example, the power increased value may be X dBm power boost, wherein X is an integer number, for example, X may be 3 or 10. In this case, the second transmission power may be determined based on the reference transmission power and the power increased value. For example, the second transmission power may be determined as: P_{PSFCH,one}=P_{O,PSFCH}+10 log₁₀ (2)+α_{PSFCH}·PL+X[dBm]. In some embodiments, the terminal device 110-1 may increase the transmission power on each resource of the set of dedicated resources. Alternatively, the terminal device 110-1 may increase the transmission power on a subset of the set of dedicated resources. In this way, more remaining power can be used for HARQ-ACK/NACK information on dedicated resources. In this case, as a consequence, a coverage of PSFCH transmission of HARQ-ACK information can be increased.

In some embodiments, the power increased value may be compared with the reference transmission power on the common resource. For example, energy per resource element (EPRE) on each dedicated resource (in dBm) may equal to the power increased value plus the EPRE on each common resource (in dBm). In some embodiments, the second transmission power may be below a PSD limit threshold, for example, (10+10*log 10((N2*12*15*10\hat{ }3*2\hat{ }μ)/(10\hat{ }6)) dBm=(10*log 10(N2*18*2\hat{ }μ)−10) dBm=10*log 10(N2*1.8*2\hat{ }μ) dBm.

In some embodiments, a set of reserved resources neighboring to the set of common resources may be reserved as guard band. In some embodiments, the reservation of resources neighboring to the set of common resources and the reduced transmission power for the common information may be combined in one example embodiment or may be implemented separately in different embodiments. In some embodiments, the terminal device 110-1 may obtain another configuration that indicates the set of reserved resources neighboring to the set of common resources. In some embodiments, the other configuration may be obtained from high layer parameters. Alternatively, the network device 120 may transmit the other configuration to the terminal device 110-1. In this way, the PSD limit requirement can be satisfied, and IBE can be mitigated.

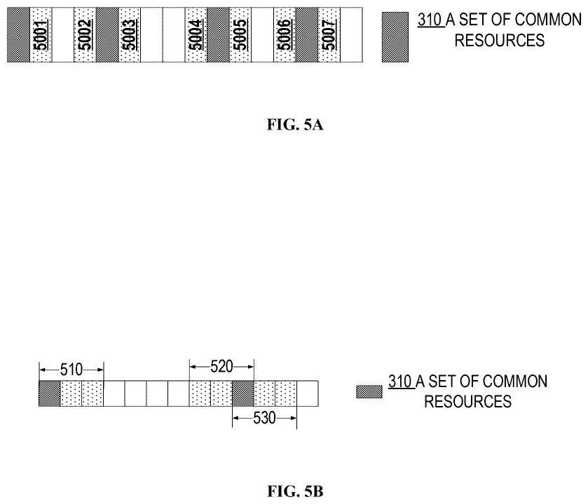

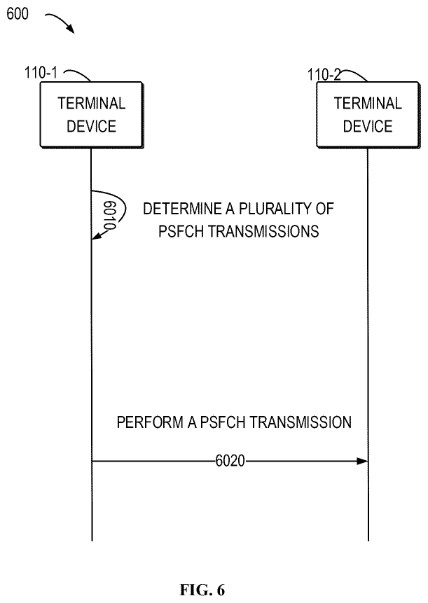

In some embodiments, the set of reserved resources may include a predetermined number of PRBs adjacent to each resource in the set of common resources. For example, adjacent k PRBs around each of the common resource may be reserved as guard PRBs, to ensure the power in a certain 1 MHz bandwidth is below the PSD limit. In this case, k may be an integer number. By way of example, if k is 1, as shown in FIG. 5A, PRB 5001 around the common resource, PRBs 5002 and 5003 around the common resource, PRBs 5004 and 5005 around the common resource and PRBs 5006 and 5007 around the common resource may be reserved. It is noted that the PRBs shown in FIG. 5A are only examples not limitations.

In some other embodiments, the set of reserved resources may include a predetermined bandwidth adjacent to the set of common resources. For example, the predetermined bandwidth may be 1 MHz. The predetermined bandwidth may include the common resources. Alternatively, the predetermined bandwidth may not include the common resources. By way of example, as shown in FIG. 5B, the bandwidth 510 around the common resource, the bandwidth 520 around the common resource and the bandwidth 530 around the common resource may be reserved. It is noted that the PRBs and bandwidths shown in FIG. 5B are only examples not limitations.

According to embodiments of the present disclosure described with reference to FIGS. 2-5B, the transmission power for the common information can be reduced. In this way, more remaining power can be used for the HARQ-ACK information.

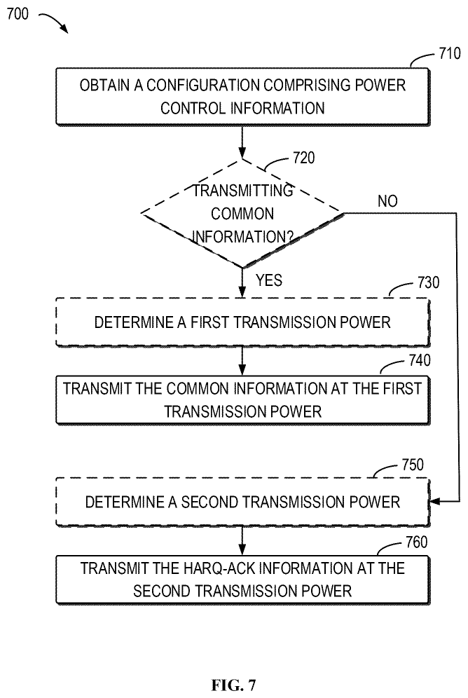

Embodiments of the present disclosure will be described in detail below. Reference is first made to FIG. 6, which shows a signaling chart illustrating process 600 among the terminal device and the network device according to some example embodiments of the present disclosure. Only for the purpose of discussion, the process 600 will be described with reference to FIG. 1. For example, the process 600 may involve the terminal device 110-1 and the terminal device 110-2.

The terminal device 110-1 determines (6010) a plurality of PSFCH transmissions in a PSFCH occasion. The plurality of PSFCH transmissions is used for one or more of: HARQ-ACK information, conflict information, and common OCB information.

In some embodiments, the terminal device 110-1 may determine the number of PSFCH transmission for the common OCB information. In some embodiments, the number of PSFCH transmissions for the common OCB information may be a predetermined number. For example, if a transmission for the common OCB information includes the predetermined number of encoded data or sequences, the number of PSFCH transmissions for the common OCB information may be the predetermined number. In some embodiments, the predetermined number may be one. In some other embodiments, the number of PSFCH transmissions for the common OCB information may be N1, where N1 may be an integer number. For example, if the transmission for the common OCB information includes N1 repetitions of one encoded data or sequence, the number of PSFCH transmissions for the common OCB information may be N1. Alternatively, the number of PSFCH transmissions for the common OCB information may be preconfigured.

The terminal device 110-1 performs (6020) a PSFCH transmission for the common OCB information with the terminal device 110-1 based on priority information associated with the common OCB information. In some embodiments, the terminal device 110-1 may determine a plurality of simultaneous PSFCH transmissions. In this case, if the terminal device 110-1 determines to drop one or more of the simultaneous PSFCH transmissions, the terminal device 110-1 may determine that a priority of the PSFCH transmission for the common OCB information is higher than priorities of PSFCH transmissions for the HARQ-ACK information and the conflict information. In other words, the PSFCH transmission for the common OCB information may be prioritized over the HARQ-ACK information and the conflict information.

In some embodiments, the terminal device 110-1 may determine that one or more PSFCH transmissions to be dropped based on the number of PSFCH transmissions supported by the first terminal device based on a capability of the first terminal device. Alternatively, or in addition, the that one or more PSFCH transmissions to be dropped may be determined based on a limited total transmission power of the terminal device 110-1. In some other embodiments, the terminal device 110-1 may determine that one or more PSFCH transmissions to be dropped based on a PSD power limitation. For example, one or more PSFCH transmissions to be dropped may be determined based on the PSD power limitation within 1 MHz. In some embodiments, the PSFCH transmission for the common OCB information may be performed regardless of the PSFCH transmissions with the HARQ-ACK information and the conflict information. In other words, the common OCB information may always be transmitted. In some other embodiments, a priority value of the PSFCH transmission for the common OCB information may be set to a preconfigured value. For example, the priority value of common information transmission may be a lowest value, such as “1.” In this way, the OCB requirement can be met, and the transmission limitations can be handled.

In some embodiments, the terminal device 110-1 may determine overlapped time between the PSFCH transmission for the common OCB information and PSFCH transmissions for at least one of: the HARQ-ACK information or the conflict information. In this case, in some embodiments, the terminal device 110-1 may determine that a priority of the PSFCH transmission for the common OCB information is higher than priorities of PSFCH transmissions for at least one of: the HARQ-ACK information or the conflict information. In other words, the terminal device 110-1 may prioritize the transmission of PSFCH transmission for the common information.

Alternatively, the terminal device 110-1 may determine overlapped time between a PSFCH reception for the common OCB information and PSFCH transmissions for at least one of: the HARQ-ACK information or the conflict information. In this case, in some embodiments, the terminal device 110-1 may determine that the reception of the common OCB information to be skipped. In other words, the terminal device 110-1 may ignore the PSFCH reception for the common information. In this way, the OCB requirement can be met, and the transmission/reception overlap may be handled.

According to embodiments of the present disclosure described with reference to FIG. 6, the transmission power for the common information can be prioritized. In this way, the OCB requirement can be met.

Embodiments of the present disclosure described with reference to FIG. 6 may be implemented independently. Table 1 below shows an example embodiment of prioritizing common OCB information and no power reduction.

```
TABLE 1
Prioritize common OCB information
16.2.3  PSFCH transmission in shared spectrum
A UE with N_{sch,Tx,PSFCH} scheduled PSFCH transmissions for HARQ-ACK information,
conflict information and common OCB information and capable of transmitting a
maximum of N_{max,PSFCH} PSFCHs, determines a number N_{Tx,PSFCH} of simultaneous
PSFCH transmissions and a power P_{PSFCH,k}(i) for a PSFCH transmission k, 1 ≤ k ≤
N_{Tx,PSFCH}, on a resource pool in PSFCH transmission occasion i on active SL BWP b
of carrier f as
  - if dl-P0-PSFCH is provided,
              ${P}_{PSFCH , one} = {P}_{O , PSFCH} + 10 {log}_{10} ( {2}^{μ} ) + {α}_{PSFCH} \cdot PL [ dBm ]$
    where
    - P_{O,PSFCH} is a value of dl-P0-PSFCH
    - α_{PSFCH} is a value of dl-Alpha-PSFCH, if provided; else, α_{PFSCH} = 1
        - PL = PL_{b,f,c}(q_{d}) when the active SL BWP is on a serving cell c, as
          described in clause 7.1.1 except that
          - the RS resource is the one the UE uses for determining a power of a
            PUSCH transmission scheduled by a DCI format 0_0 in serving cell c
            when the UE is configured to monitor PDCCH for detection of DCI
            format 0_0 in serving cell c
          - the RS resource is the one corresponding to the SS/PBCH block the UE
            uses to obtain MIB when the UE is not configured to monitor PDCCH for
            detection of DCI format 0_0 in serving cell c
    - if N_{sch,Tx,PSFCH} ≤ N_{max,PSFCH}
        -if P_{PSFCH,one} + 10log₁₀(N_{sch,Tx,PSFCH}) ≤ P_{CMAX}, where P_{CMAX} is
        determined for N_{sch,Tx,PSFCH} PSFCH transmissions according to [8-1, TS
        38.101-1]
        - N_{Tx,PSFCH} = N_{sch,Tx,PSFCH} and P_{PSFCH,k} (i) = P_{PSFCH,one} [dBm]
    - else
        - UE autonomously determines N_{Tx,PSFCH} PSFCH transmissions first with
          PSFCH transmission with common OCB information, if any, and then
          with ascending order of corresponding priority field values as described in
          clause 16.2.4.2 over the PSFCH transmissions with HARQ-ACK
          information, if any, and then with ascending order of priority value over
          the PSFCH transmissions with conflict information, if any, such that
          ${N}_{Tx , PSFCH} \geq max ( 1 , N\_c + {\sum }_{i = 1}^{K} {M}_{i} ) where N\_c is the number counted$
          for common OCB information transmission, and Mᵢ, for 1 ≤ i ≤ 8, is a
          number of PSFCHs with priority value i for PSFCH with HARQ-ACK
          information and Mᵢ, for i > 8, is a number of PSFCHs with priority
          value i − 8 for PSFCH with conflict information and K is defined as
          $[ \begin{matrix}the largest value satisfying {P}_{PSFCH , one} + 10 {log}_{10} ( max ( 1 , N\_c + {\sum }_{i = 1}^{K} {M}_{i} ) ) \leq \\ {\sum }_{i = 1}^{K} {M}_{i} ) ) \leq {P}_{CMAX} where {P}_{CMAX} is determined according to [ 8 - 1 , \\ TS 38.101 - 1 ] for transmission of all PSFCHs in {\sum }_{i = 1}^{K} {M}_{i} , if any\end{matrix} ]$
          - zero, otherwise
          and
          ${P}_{PSFCH , k} ( i ) = min ( {P}_{CMAX} - 1 0 {log}_{10} ( {N}_{T x , PSFCH} ) , {P}_{PSFCH , o n e} ) [ dBm ]$
          where P_{CMAX} is defined in [8-1, TS 38.101-1] and is determined for the
          N_{Tx,PSFCH} PSFCH transmissions
    - else
        - the UE autonomously selects N_{max,PSFCH} PSFCH transmissions with
          ascending order of corresponding priority field values as described in clause
          16.2.4.2
          - if P_{PSFCH,one} + 10log₁₀(N_{max,PSFCH}) ≤ P_{CMAX}, where P_{CMAX} is
              determined for the N_{max,PSFCH} PSFCH transmissions according to [8-1,
              TS 38.101-1]
              - N_{Tx,PSFCH} = N_{max,PSFCH} and P_{PSFCH,k}(i) = P_{PSFCH,one} [dBm]
          - else
              - the UE autonomously selects N_{Tx,PSFCH} PSFCH transmissions first
                with PSFCH transmission with common OCB information, if any, and
                then in ascending order of corresponding priority field values as
                described in clause 16.2.4.2 over the PSFCH transmissions with
                HARQ-ACK information, if any, and then with ascending order of
                priority value over the PSFCH transmissions with conflict information,
                $if any , such that {N}_{Tx , PSFCH} \geq max ( 1 , N\_c + {\sum }_{i = 1}^{K} {M}_{i} ) where N\_c is$
                the number counted for common OCB information transmission, and
                Mᵢ, 1 ≤ i ≤ 8, is a number of PSFCHs with priority value i for
                PSFCH with HARQ-ACK information and Mᵢ, i > 8, is a number of
                PSFCHs with priority value i − 8 for PSFCH with conflict
                information and K is defined as
              - $[ \begin{matrix}the largest value satisfying {P}_{PSFCH , one} + 10 {log}_{10} ( max ( 1 , N\_c + \\ {\sum }_{i = 1}^{K} {M}_{i} ) ) \leq {P}_{CMAX} where {P}_{CMAX} is determined according to [ 8 - 1 , \\ TS 38.101 - 1 ] for transmission of all PSFCHs in {\sum }_{i = 1}^{K} {M}_{i} , if any\end{matrix} ]$
              TS 38.101-1] for transmission of all PSFCHs in 20-1 Mi, if any
              - zero, otherwise
              and
          ${P}_{PSFCH , k} ( i ) = min ( {P}_{CMAX} - 10 {log}_{10} ( {N}_{T x , PSFCH} ) , {P}_{PSFCH , o n e} ) [ dBm ]$
              where P_{CMAX} is determined for the N_{Tx,PSFCH} simultaneous PSFCH
              transmissions according to [8-1, TS 38.101-1]
  - else
              ${P}_{PSFCH , k} ( i ) = {P}_{CMAX} - 10 {log}_{10} ( {N}_{T x , PSFCH} ) [ dBm ]$
    where the UE autonomously determines N_{Tx,PSFCH} PSFCH transmissions first
    with PSFCH transmission with common OCB information, if any, and then with
    ascending order of corresponding priority field values as described in clause
    16.2.4.2 over the PSFCH transmissions with HARQ-ACK information, if any, and
    then with ascending order of priority value over the PSFCH transmissions with
    conflict information, if any, such that N_{Tx,PSFCH} ≥ 1 and where P_{CMAX} is
    determined for the N_{Tx,PSFCH} PSFCH transmissions according to [8-1, TS 38.101-
    1].
16.2.4  Prioritization of transmissions/receptions
16.2.4.2  Simultaneous PSFCH transmission/reception
For PSFCH transmission with common OCB information:
    It's always prioritized over other transmissions.
    A priority value for the PSFCH is equal to the smallest priority value 1.
For a PSFCH transmission or reception with HARQ-ACK information, a priority value
for the PSFCH is equal to the priority value indicated by an SCI format 1-A associated
with the PSFCH.
For PSFCH transmission with conflict information, a priority value for the PSFCH is
equal to the smallest priority value determined by the corresponding SCI formats 1-A for
the conflicting resources.
For PSFCH reception with conflict information, a priority value for the PSFCH is equal
to the priority value determined by the corresponding SCI format 1-A for the conflicting
resource.
If a UE
  - would transmit N_{sch,Tx,PSFCH} PSFCHs and receive N_{sch,Rx,PSFCH} PSFCHs, and
  - transmissions of the N_{sch,Tx,PSFCH} PSFCHs would overlap in time with receptions
    of the N_{sch,Rx,PSFCH} PSFCHs
the UE transmits the PSFCH with common OCB information, and transmits or receives
only a set of PSFCHs corresponding to the smallest priority field value, as determined by
a first set of SCI format 1-A and/or a second set of SCI format 1-A [5, TS 38.212] that
are respectively associated with PSFCHs with HARQ-ACK information from the
N_{sch,Tx,PSFCH} PSFCHs and PSFCHs with HARQ-ACK information from the
N_{sch,Rx,PSFCH} PSFCHs when one or more of the PSFCHs provide HARQ-ACK
information. If none of the N_{sch,Tx,PSFCH} PSFCHs and none of the N_{sch,Rx,PSFCH}
PSFCHs provide HARQ-ACK information, the UE transmits or receives only a set of
PSFCHs corresponding to the smallest priority value of the first set of PSFCHs and the
second set of PSFCHs that are respectively associated with the N_{sch,Tx,PSFCH} PSFCHs
and the N_{sch,Rx,PSFCH} PSFCHs when the PSFCHs provide conflict information..
If a UE would transmit N_{sch,Tx,PSFCH} PSFCHs in a PSFCH transmission occasion, the
UE first transmits the PSFCH with common OCB information, and then transmits
PSFCHs with HARQ-ACK information from N_{Tx,PSFCH} PSFCHs corresponding to the
smallest priority field values from the N_{Tx,PSFCH} priority field values. Subsequently, the
UE transmits remaining PSFCHs with conflict information corresponding to the smallest
remaining priority field values from the N_{Tx,PSFCH} priority field values, if any.
If a UE indicates a capability to receive N_{Rx,PSFCH} PSFCHs in a PSFCH reception
occasion [18, TS 38.306], the UE first receives PSFCHs with HARQ-ACK information,
if any, and subsequently receives PSFCHs with conflict information, if any.
```

Alternatively, embodiments of the present disclosure described with reference to FIG. 6 and embodiments of the present disclosure described with reference to FIG. 2 may be implemented together. Table 2 below shows an example of prioritizing common OCB information and power reduction.

```
TABLE 2
Prioritize common OCB information, and
Power reduction for common OCB information
16.2.3 PSFCH transmission in shared spectrum
A UE with N_{sch,Tx,PSFCH} scheduled PSFCH transmissions for HARQ-ACK information,
conflict information and N_c scheduled PSFCH transmissions with common OCB
information and capable of transmitting a maximum of N_{max,PSFCH} PSFCHs,
determines a number N_{Tx,PSFCH} of simultaneous PSFCH transmissions and a power
P_{PSFCH,k}(i) for a PSFCH transmission k with HARQ-ACK information and conflict
information, 1 ≤ k ≤ N_{Tx,PSFCH}, and N_c PSFCH transmission with common OCB
information and total transmit power P_{PSFCH,common} on a resource pool in PSFCH
transmission occasion i on active SL BWP b of carrier f as
  - if dl-P0-PSFCH is provided,
${P}_{PSFCH , one} = {P}_{O , PSFCH} + 10 {log}_{10} ( {2}^{μ} ) + {α}_{PSFCH} \cdot PL [ dBm ]$ $OR$ ${P}_{PSFCH , one} = {P}_{O , PSFCH} + 10 {log}_{10} ( {2}^{μ} ) + {α}_{PSFCH} \cdot PL + X [ dBm ]$ ${P}_{PSFCH , common} = {P}_{O , PSFCH} + 10 {log}_{10} ( {2}^{μ} * N 1 ) + {α}_{PSFCH} \cdot PL [ dBm ]$ $OR$ ${P}_{PSFCH , common} = {P}_{O , PSFCH} + 10 {log}_{10} ( {2}^{μ} * N 1 ) + {α}_{PSFCH} \cdot PL - Y [ dBm ] where$
  - P_{O,PSFCH} is a value of dl-P0-PSFCH
  - α_{PSFCH} is a value of dl-Alpha-PSFCH, if provided; else, α_{PSFCH} = 1
    - PL = PL_{b,f,c}(q_{d}) when the active SL BWP is on a serving cell c, as
        described in clause 7.1.1 except that
        - the RS resource is the one the UE uses for determining a power of a
          PUSCH transmission scheduled by a DCI format 0_0 in serving cell c
          when the UE is configured to monitor PDCCH for detection of DCI
          format 0_0 in serving cell c
        - the RS resource is the one corresponding to the SS/PBCH block the UE
          uses to obtain MIB when the UE is not configured to monitor PDCCH for
          detection of DCI format 0_0 in serving cell c
  - if N_{sch,Tx,PSFCH} + N_c _ N_{max,PSFCH}
    - if P_{PSFCH,one} + P_{PSFCH,common} + 10log₁₀ (N_{sch,Tx,PSFCH} ) ≤ P_{CMAX}, where
        P_{CMAX} is determined for N_{sch,Tx,PSFCH} PSFCH transmissions according to
        [8-1, TS 38.101-1]
        - N_{Tx,PSFCH} = N_{sch,Tx,PSFCH} and P_{PSFCH,k}(i) = P_{PSFCH,one} [dBm]
    - else
        - UE autonomously determines N_{Tx,PSFCH} PSFCH transmissions first with
          PSFCH transmission with common OCB information, if any, and then
          with ascending order of corresponding priority field values as described in
          clause 16.2.4.2 over the PSFCH transmissions with HARQ-ACK
          information, if any, and then with ascending order of priority value over
          the PSFCH transmissions with conflict information, if any, such that
          ${N}_{Tx , PFSCH} \geq max ( 1 , {\sum }_{i = 1}^{K} {M}_{i} ) where {M}_{i} , 1 \leq i \leq 8 , is a number of$
          PSFCHs with priority value i for PSFCH with HARQ-ACK information
          and Mᵢ, for i > 8, is a number of PSFCHs with priority value i − 8 for
          PSFCH with conflict information and K is defined as
          -  $the largest value satisfying {P}_{PSFCH , one} + {P}_{PSFCH , common} +$ $10 {log}_{10} ( max ( 1 , {\sum }_{i = 1}^{K} {M}_{i} ) ) \leq {P}_{CMAX} where {P}_{CMAX} is determined$
            according to [8-1, TS 38.101-1] for transmission of all PSFCHs in
            ${\sum }_{i = 1}^{K} {M}_{i} , if any$
          - zero, otherwise
          and
        ${P}_{PSFCH , k} ( i ) = min ( {P}_{CMAX} - 10 {log}_{10} ( {N}_{T x , PSFCH} ) , {P}_{PSFCH , o n e} ) [ dBm ]$
          where P_{CMAX} is defined in [8-1, TS 38.101-1] and is determined for the
          N_{Tx,PSFCH} PSFCH transmissions
  - else
    - the UE autonomously selects N_{max,PSFCH} PSFCH transmissions with
        ascending order of corresponding priority field values as described in clause
        16.2.4.2
        - if P_{PSFCH,one} + P_{PSFCH,common} + 10log₁₀ (N_{max,PSFCH} ) ≤ P_{CMAX}, where
          P_{CMAX} is determined for the N_{max,PSFCH} PSFCH transmissions according
          to [8-1, TS 38.101-1]
          - N_{Tx,PSFCH} = N_{max,PSFCH} and P_{PSFCH,k} (i) = P_{PSFCH,one} [dBm]
        - else
          - the UE autonomously selects N_{Tx,PSFCH} PSFCH transmissions first
            with PSFCH transmission with common OCB information, if any, and
            then in ascending order of corresponding priority field values as
            described in clause 16.2.4.2 over the PSFCH transmissions with
            HARQ-ACK information, if any, and then with ascending order of
            priority value over the PSFCH transmissions with conflict information,
            $i f any , such that {N}_{Tx , PSFCH} \geq max ( 1 , {\sum }_{i = 1}^{K} {M}_{i} ) where {M}_{i} , 1 \leq i \leq 8 ,$
            is a number of PSFCHs with priority value i for PSFCH with HARQ-
            ACK information and Mᵢ, i > 8, is a number of PSFCHs with priority
            value i − 8 for PSFCH with conflict information and K is defined as
            $the largest value satisfying {P}_{PSFCH , one} + {P}_{PSFCH , common} +$ $10 {log}_{10} ( max ( 1 , {\sum }_{i = 1}^{K} {M}_{i} ) ) \leq {P}_{CMAX} where {P}_{CMAX} is determined$
            according to [8-1, TS 38.101-1] for transmission of all PSFCHs in
            ${\sum }_{i = 1}^{K} {M}_{i} , if any$
            - zero, otherwise
            and
        ${P}_{PSFCH , k} ( i ) = min ( {P}_{CMAX} - 10 {log}_{10} ( {N}_{T x , PSFCH} ) , {P}_{PSFCH , o n e} ) [ dBm ]$
            where P_{CMAX} is determined for the N_{Tx,PSFCH} simultaneous PSFCH
            transmissions according to [8-1, TS 38.101-1]
  - else
              ${P}_{PSFCH , k} ( i ) = {P}_{CMAX} - 10 {log}_{10} ( {N}_{Tx , PSFCH} ) [ dBm ]$
    where the UE autonomously determines N_{Tx,PSFCH} PSFCH transmissions first
    with PSFCH transmission with common OCB information, if any, and then with
    ascending order of corresponding priority field values as described in clause
    16.2.4.2 over the PSFCH transmissions with HARQ-ACK information, if any, and
    then with ascending order of priority value over the PSFCH transmissions with
    conflict information, if any, such that N_{Tx,PSFCH} ≥ 1 and where P_{CMAX} is
    determined for the N_{Tx,PSFCH} PSFCH transmissions according to [8-1, TS 38.101-
    1].
16.2.4 Prioritization of transmissions/receptions
16.2.4.2 Simultaneous PSFCH transmission/reception
For PSFCH transmission with common OCB information:
    It's always prioritized over other transmissions.
    A priority value for the PSFCH is equal to the smallest priority value.
For a PSFCH transmission or reception with HARQ-ACK information, a priority value
for the PSFCH is equal to the priority value indicated by an SCI format 1-A associated
with the PSFCH.
For PSFCH transmission with conflict information, a priority value for the PSFCH is
equal to the smallest priority value determined by the corresponding SCI formats 1-A for
the conflicting resources.
For PSFCH reception with conflict information, a priority value for the PSFCH is equal
to the priority value determined by the corresponding SCI format 1-A for the conflicting
resource.
If a UE
  - would transmit N_{sch,Tx,PSFCH} PSFCHs and receive N_{sch,Rx,PSFCH} PSFCHs, and
  - transmissions of the N_{sch,Tx,PSFCH} PSFCHs would overlap in time with receptions
    of the N_{sch,Rx,PSFCH} PSFCHs
the UE transmits the PSFCH with common OCB information, and transmits or receives
only a set of PSFCHs corresponding to the smallest priority field value, as determined by
a first set of SCI format 1-A and/or a second set of SCI format 1-A [5, TS 38.212] that
are respectively associated with PSFCHs with HARQ-ACK information from the
N_{sch,Tx,PSFCH} PSFCHs and PSFCHs with HARQ-ACK information from the
N_{sch,Rx,PSFCH} PSFCHs when one or more of the PSFCHs provide HARQ-ACK
information. If none of the N_{sch,Tx,PSFCH} PSFCHs and none of the N_{sch,Rx,PSFCH}
PSFCHs provide HARQ-ACK information, the UE transmits or receives only a set of
PSFCHs corresponding to the smallest priority value of the first set of PSFCHs and the
second set of PSFCHs that are respectively associated with the N_{sch,Tx,PSFCH} PSFCHs
and the N_{sch,Rx,PSFCH} PSFCHs when the PSFCHs provide conflict information..
If a UE would transmit N_{sch,Tx,PSFCH} PSFCHs in a PSFCH transmission occasion, the
UE first transmits the PSFCH with common OCB information, and then transmits
PSFCHs with HARQ-ACK information from N_{Tx,PSFCH} PSFCHs corresponding to the
smallest priority field values from the N_{Tx,PSFCH} priority field values. Subsequently, the
UE transmits remaining PSFCHs with conflict information corresponding to the smallest
remaining priority field values from the N_{Tx,PSFCH} priority field values, if any.
If a UE indicates a capability to receive N_{Rx,PSFCH} PSFCHs in a PSFCH reception
occasion [18, TS 38.306], the UE first receives PSFCHs with HARQ-ACK information,
if any, and subsequently receives PSFCHs with conflict information, if any.
```

FIG. 7 shows a flowchart of an example method 700 in accordance with an embodiment of the present disclosure. The method 700 can be implemented at any suitable terminal devices. Only for the purpose of illustrations, the method 700 can be implemented at a terminal device 110-1 as shown in FIG. 1.

At block 710, the terminal device 110-1 obtains a configuration that comprises comprises power control information concerning a sidelink transmission related to the terminal device 110-1. At block 720, the terminal device 110-1 may determine whether to transmit common information or not.

If common information is to be transmitted on a set of common resources, at block 730, the terminal device 110-1 may determine a first transmission power based on a reference transmission power in the power control information and a power reduction value. In some embodiments, the power control information indicates the power reduction value for the sidelink transmission on the set of common resources. At block 740, the terminal device 110-1 transmits the common information at the first transmission power on the set of common resources to the terminal device 110-2.

If HARQ-ACK information is to be transmitted on a set of dedicated resources, at block 750, the terminal device 110-1 may determine a second transmission power. At block 760, the terminal device 110-1 transmits the HARQ-ACK information at the second transmission power on the set of dedicated resources to the terminal device 110-2.

In some embodiments, the set of common resources comprises: a number of interlaced physical resource blocks (PRBs), or a number of PRBs located in at least one boundary of a resource block set for the sidelink transmission. In some embodiments, the set of dedicated resources comprises a number of PRBs.

In some embodiments, the second transmission power may be determined based on the reference transmission power and a power increased value indicated in the power control information. In some embodiments, the second transmission power may be below a power spectral density (PSD) limit threshold.

In some embodiments, if a condition concerning PSD is satisfied, the terminal device 110-1 may determine the first transmission power based on the power reduction value and the reference transmission power. In some embodiments, the condition concerning PSD is that power in a predetermined bandwidth exceeds a PSD limit threshold.

In some embodiments, the terminal device 110-1 may obtain another configuration indicating that a set of reserved resources neighboring to the set of common resources is reserved. In some embodiments, the set of reserved resources comprises a predetermined number of PRBs adjacent to each resource in the set of common resources. In some embodiments, the set of reserved resources comprises a predetermined bandwidth adjacent to the set of common resources.

In some embodiments, the terminal device 110-1 may transmit the common information in a set of waveforms on the set of common resources, wherein the set of waveforms is with different phase positions. In some embodiments, the terminal device 110-1 may determine the set of waveforms based on an identity of the first terminal device.

FIG. 8 shows a flowchart of an example method 800 in accordance with an embodiment of the present disclosure. The method 800 can be implemented at any suitable terminal devices. Only for the purpose of illustrations, the method 800 can be implemented at a terminal device 110-1 as shown in FIG. 1.

At block 810, the terminal device 110-1 determines a plurality of physical sidelink feedback channel (PSFCH) transmissions in a PSFCH occasion. The plurality of PSFCH transmissions is used for at least one of: hybrid automatic repeat request acknowledgment (HARQ-ACK) information, conflict information and common occupied channel bandwidth (OCB) information.

At block 820, the terminal device 110-1 performs a PSFCH transmission for the common OCB information with the terminal device 110-2 based on priority information associated with the common OCB information. In some embodiments, the number of PSFCH transmissions for the common OCB information is the predetermined number. In some embodiments, the number of PSFCH transmissions for the common OCB information is N1, wherein N1 is an integer number. In some embodiments, the number of PSFCH transmissions for the common OCB information is preconfigured.

In some embodiments, the terminal device 110-1 may determine a plurality of simultaneous PSFCH transmissions. In this case, if at least one of the simultaneous PSFCH transmissions is dropped, the terminal device 110-1 may determine that a priority of the PSFCH transmission for the common OCB information is higher than priorities of PSFCH transmissions for the HARQ-ACK information and the conflict information.

In some embodiments, the terminal device 110-1 may determine that at least one of the simultaneous PSFCH transmissions is dropped based on at least one of: the number of PSFCH transmissions supported by the first terminal device based on a capability of the first terminal device, a limited total transmission power of the first terminal device, or a power spectral density (PSD) power limitation.

In some embodiments, the PSFCH transmission for the common OCB information is performed regardless of the PSFCH transmissions for the HARQ-ACK information and the conflict information. In some embodiments, a priority value of the PSFCH transmission for the common OCB information is set to a preconfigured value.

In some embodiments, if there is overlapped time between the PSFCH transmission for the common OCB information and PSFCH transmissions for at least one of: the HARQ-ACK information or the conflict information, the terminal device 110-1 may determine that a priority of the PSFCH transmission for the common OCB information is higher than priorities of PSFCH transmissions for at least one of: the HARQ-ACK information or the conflict information. In some embodiments, if there is overlapped time between a PSFCH reception for the common OCB information and PSFCH transmissions for at least one of the HARQ-ACK information or the conflict information, the terminal device 110-1 may determine that the reception of the common OCB information to be skipped.

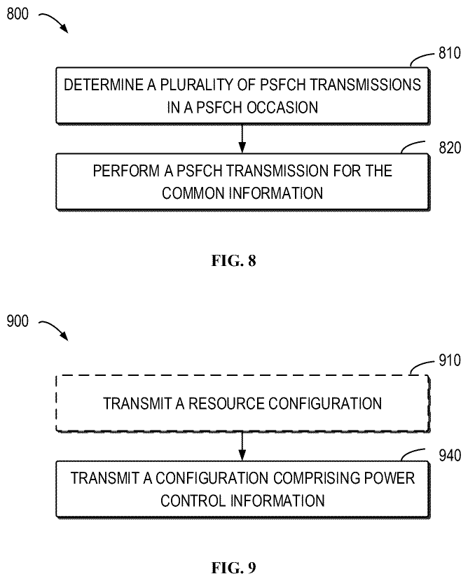

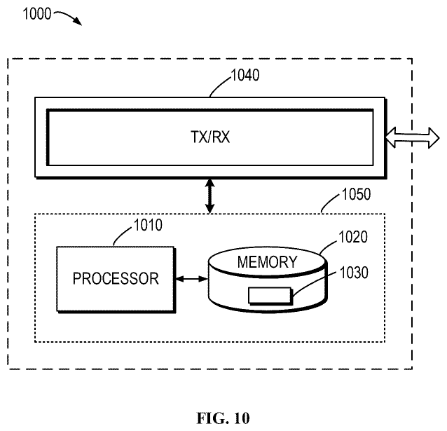

FIG. 9 shows a flowchart of an example method 900 in accordance with an embodiment of the present disclosure. The method 900 can be implemented at any suitable terminal devices. Only for the purpose of illustrations, the method 900 can be implemented at a network device 120 as shown in FIG. 1.

In some embodiments, at block 910, the network device 120 may transmit a resource configuration to the terminal device 110-1. The resource configuration may indicate a set of dedicated resources and a set of common resources. In some embodiments, the set of common resources comprises: a number of interlaced physical resource blocks (PRBs), or a number of PRBs located in at least one boundary of a resource block set for the sidelink transmission. In some embodiments, the set of dedicated resources comprises a number of PRBs.

At block 920, the network device 120 transmits a configuration that comprises power control information concerning a sidelink transmission related to the terminal device 110-1. A first transmission power for transmitting common information on the set of common resources is determined based on a reference transmission power in the power control information and a power reduction value. A second transmission power for transmitting HARQ-ACK information on the set of dedicated resources is determined based on the reference transmission power and a power increased value. In some embodiments, the power control information indicates the power reduction value for the sidelink transmission on the set of common resources. In some embodiments, the power control information indicates a power increased value. In some embodiments, the network device 120 may transmit another configuration indicating that a set of reserved resources neighboring to the set of common resources is reserved to the terminal device 110-1.

FIG. 10 is a simplified block diagram of a device 1000 that is suitable for implementing embodiments of the present disclosure. The device 1000 can be considered as a further example implementation of the terminal device 110 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX)/receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a first terminal device comprises a circuitry configured to perform: obtaining a configuration that comprises power control information concerning a sidelink transmission related to the first terminal device; in accordance with a determination of common information to be transmitted on a set of common resources, transmitting, to a second terminal device, the common information at a first transmission power, wherein the first transmission power is determined based on a reference transmission power in the power control information and a power reduction value; and in accordance with a determination of hybrid-automatic repeat request acknowledgment (HARQ-ACK) information to be transmitted on a set of dedicated resources, transmitting, to the second terminal device, the HARQ-ACK information at a second transmission power. In some embodiments, the circuitry may be configured to perform the above methods.

In some embodiments, the first terminal device comprises a circuitry configured to perform: determining, at a first terminal device, a plurality of physical sidelink feedback channel (PSFCH) transmissions in a PSFCH occasion, wherein the plurality of PSFCH transmissions is used for at least one of hybrid automatic repeat request acknowledgment (HARQ-ACK) information, conflict information and common occupied channel bandwidth (OCB) information; and performing a PSFCH transmission for the common OCB information with a second terminal device based on priority information associated with the common OCB information. In some embodiments, the circuitry may be configured to perform the above methods.

In some embodiments, a network device comprises a circuitry configured to: transmitting a configuration that comprises power control information concerning a sidelink transmission related to the terminal device, wherein a first transmission power for transmitting common information on a set of common resources is determined based on a reference transmission power in the power control information and a power reduction value, and a second transmission power for transmitting hybrid-automatic repeat request acknowledgement (HARQ-ACK) information on a set of dedicated resources is determined based on the reference transmission power and a power increased value. In some embodiments, the circuitry may be configured to perform the above methods.

In some embodiments, a network device comprises a circuitry configured to perform: transmitting, to a terminal device, a configuration indicating a bandwidth part (BWP) associated to sounding reference signal (SRS) positioning. In some embodiments, the circuitry may be configured to perform the above methods.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a terminal device comprises a processor configured to cause the terminal device to: obtain a configuration that comprises power control information concerning a sidelink transmission related to the first terminal device; in accordance with a determination of common information to be transmitted on a set of common resources, transmit, to another terminal device, the common information at a first transmission power, wherein the first transmission power is determined based on a reference transmission power in the power control information and a power reduction value; and in accordance with a determination of hybrid-automatic repeat request acknowledgment (HARQ-ACK) information to be transmitted on a set of dedicated resources, transmit, to the other terminal device, the HARQ-ACK information at a second transmission power.

In the solution, the set of common resources comprises: a number of interlaced physical resource blocks (PRBs), or a number of PRBs located in at least one boundary of a resource block set for the sidelink transmission.

In the solution, the set of dedicated resources comprises a number of PRBs.

In the solution, the power control information indicates the power reduction value for the sidelink transmission on the set of common resources.

In the solution, the second transmission power is determined based on the reference transmission power and a power increased value indicated in the power control information.

In the solution, the second transmission power is below a power spectral density (PSD) limit threshold.

In the solution, the processor is further configured to cause the terminal device to: in accordance with a determination that a condition concerning PSD is satisfied, determine the first transmission power based on the power reduction value and the reference transmission power.

In the solution, the condition concerning PSD is that power in a predetermined bandwidth exceeds a PSD limit threshold.

In the solution, the processor is further configured to cause the terminal device to: obtain another configuration indicating that a set of reserved resources neighboring to the set of common resources is reserved.

In the solution, the set of reserved resources comprises a predetermined number of PRBs adjacent to each resource in the set of common resources, or wherein the set of reserved resources comprises a predetermined bandwidth adjacent to the set of common resources.

In the solution, the processor is further configured to cause the terminal device to transmit the common information in a set of waveforms on the set of common resources, wherein the set of waveforms is with different phase positions.

In the solution, the processor is further configured to cause the terminal device to determine the set of waveforms based on an identity of the first terminal device.

In another solution, a terminal device comprises: a processor configured to determine a plurality of physical sidelink feedback channel (PSFCH) transmissions in a PSFCH occasion, wherein the plurality of PSFCH transmissions is used for at least one of: hybrid automatic repeat request acknowledgment (HARQ-ACK) information, conflict information and common occupied channel bandwidth (OCB) information; and perform a PSFCH transmission for the common OCB information with another terminal device based on priority information associated with the common OCB information.

In the solution, the number of PSFCH transmissions for the common OCB information is the predetermined number, or the number of PSFCH transmissions for the common OCB information is N1, wherein N1 is an integer number, or the number of PSFCH transmissions for the common OCB information is preconfigured.

In the solution, the processor is further configured to cause the terminal device to determine a plurality of simultaneous PSFCH transmissions; and in accordance with a determination that at least one of the simultaneous PSFCH transmissions is dropped, determine that a priority of the PSFCH transmission for the common OCB information is higher than priorities of PSFCH transmissions for the HARQ-ACK information and the conflict information.

In the solution, the processor is further configured to cause the terminal device to determine that at least one of the simultaneous PSFCH transmissions is dropped based on at least one of: the number of PSFCH transmissions supported by the first terminal device based on a capability of the first terminal device, a limited total transmission power of the first terminal device, or a power spectral density (PSD) power limitation.

In the solution, the PSFCH transmission for the common OCB information is performed regardless of the PSFCH transmissions for the HARQ-ACK information and the conflict information, or a priority value of the PSFCH transmission for the common OCB information is set to a preconfigured value.

In the solution, the processor is further configured to cause the terminal device to in accordance with a determination that there is overlapped time between the PSFCH transmission for the common OCB information and PSFCH transmissions for at least one of: the HARQ-ACK information or the conflict information, determine that a priority of the PSFCH transmission for the common OCB information is higher than priorities of PSFCH transmissions for at least one of: the HARQ-ACK information or the conflict information.

In the solution, the processor is further configured to cause the terminal device to in accordance with a determination that there is overlapped time between a PSFCH reception for the common OCB information and PSFCH transmissions for at least one of: the HARQ-ACK information or the conflict information, determine that the reception of the common OCB information to be skipped.

In another solution, a network device comprises: a processor configured to cause the network device to transmit a configuration that comprises power control information concerning a sidelink transmission related to the terminal device 110-1, wherein first transmission power for transmitting common information on the set of common resources is determined based on a reference transmission power in the power control information and a power reduction value, and a second transmission power for transmitting HARQ-ACK information on the set of dedicated resources is determined based on the reference transmission power and a power increased value.

In the solution, the power control information indicates the power reduction value for the sidelink transmission on the set of common resources.

In the solution, the power control information indicates a power increased value.

In the solution, the processor is further configured to the network device to transmit another configuration indicating that a set of reserved resources neighboring to the set of common resources is reserved to the terminal device.

In the solution, the processor is further configured to cause the network device to transmit a resource configuration to the terminal device.

In the solution, the resource configuration may indicate a set of dedicated resources and a set of common resources.

In the solution, the set of common resources comprises: a number of interlaced physical resource blocks (PRBs), or a number of PRBs located in at least one boundary of a resource block set for the sidelink transmission.

In the solution, the set of dedicated resources comprises a number of PRBs.

In another solution, a computer readable medium having instructions stored thereon, the instructions, when executed on at least one processor, causing the at least one processor to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a terminal device, comprising:
receiving configuration information comprising a power offset value; and
determining physical resource blocks (PRBs) in a common interlace and dedicated PRBs, within a resource block set, for a Physical Sidelink Feedback Channel (PSFCH) transmission with hybrid automatic repeat request acknowledgement (HARQ-ACK) information,
wherein a first power on one PRB in the common interlace for the PSFCH transmission is obtained by subtracting the power offset value from a second power.

22. The method of claim 21, wherein the second power is P_{PSFCH,one}=P_{O,PSFCH}+10 log₁₀(2^{μ})+α_{PSFCH}·PL [dBm]
where P_{O,PSFCH} represents a value of dl-P0-PSFCH,
α_{PSFCH} represents a value of dl-Alpha-PSFCH, if provided; else, α_{PFSCH}=1,
PL=PL_{b,f,c}(q_{d}) when active sidelink (SL) bandwidth part (BWP) is on a serving cell c except that: reference signal (RS) resource is the one the terminal device uses for determining a power of a physical uplink shared channel (PUSCH) transmission scheduled by a downlink control information (DCI) format 0_0 in serving cell c when the terminal device is configured to monitor physical downlink control channel (PDCCH) for detection of DCI format 0_0 in serving cell c; the RS resource is the one corresponding to the Synchronization Signal/Physical Broadcast Channel (SS/PBCH) block the terminal device uses to obtain Master Information Block (MIB) when the terminal device is not configured to monitor PDCCH for detection of DCI format 0_0 in serving cell c.

23. The method of claim 21, wherein the terminal device receives the configuration information comprising the power offset value via radio resource control (RRC) signaling from a network device.

24. A terminal device, comprising a processor configured to:
receive configuration information comprising a power offset value; and
determine physical resource blocks (PRBs) in a common interlace and dedicated PRBs, within a resource block set, for a Physical Sidelink Feedback Channel (PSFCH) transmission with hybrid automatic repeat request acknowledgement (HARQ-ACK) information,
wherein a first power on one PRB in the common interlace for the PSFCH transmission is obtained by subtracting the power offset value from a second power.

25. The terminal device of claim 24, wherein the second power is P_{PSFCH,one}=P_{O,PSFCH}+10 log₁₀(2^{μ})+α_{PSFCH}·PL [dBm]
where P_{O,PSFCH} represents a value of dl-P0-PSFCH,
α_{PSFCH} represents a value of dl-Alpha-PSFCH, if provided; else, α_{PFSCH}=1,
PL=PL_{b,f,c}(q_{d}) when active sidelink (SL) bandwidth part (BWP) is on a serving cell c except that: reference signal (RS) resource is the one the terminal device uses for determining a power of a physical uplink shared channel (PUSCH) transmission scheduled by a downlink control information (DCI) format 0_0 in serving cell c when the terminal device is configured to monitor physical downlink control channel (PDCCH) for detection of DCI format 0_0 in serving cell c; the RS resource is the one corresponding to the Synchronization Signal/Physical Broadcast Channel (SS/PBCH) block the terminal device uses to obtain Master Information Block (MIB) when the terminal device is not configured to monitor PDCCH for detection of DCI format 0_0 in serving cell c.

26. The terminal device of claim 24, wherein the terminal device receives the configuration information comprising the power offset value via radio resource control (RRC) signaling from a network device.
